(19) United States
(12) Patent Application Publication
(10) Pub. No.: US 2024/0295637 A1
(43) Pub. Date: Sep. 5, 2024

(54) TECHNIQUES FOR GALVO AFE WITH ENHANCED DYNAMIC RANGE CONTROL AND IMPROVED SENSITIVITY TO ELECTROMAGNETIC INTERFERENCE

(71) Applicant: AEVA, INC., Mountain View, CA (US)

(72) Inventors: Murat Ozbas, Penfield, NY (US); Bryce Bradford, Cupertino, CA (US); Adrit Lath, Mountain View, CA (US); Matt Last, Los Altos, CA (US)

(21) Appl. No.: 18/595,040

(22) Filed: Mar. 4, 2024

Related U.S. Application Data
(60) Provisional application No. 63/488,417, filed on Mar. 3, 2023.

(51) Int. Cl. G01S 7/481; G01D 5/30

(52) U.S. Cl. CPC G01S 7/4817; G01D 5/30; G01D 2205/20

(57) ABSTRACT

A LIDAR system includes an actuator assembly and actuator position tracking circuitry. The actuator position tracking circuity includes a light emitting diode (LED) to emit a first signal toward an actuator, a photodiode to receive a second signal based on a position of the actuator and generate an output signal, and at least one front-end electronics to produce a low-impedance analog electrical signal based on the output signal.

### RELATED APPLICATIONS

This application claims priority from and the benefit of U.S. Provisional Patent Application No. 63/488,417 filed on Mar. 3, 2023, the entire contents of which are incorporated herein by reference in their entirety.

### TECHNICAL FIELD

The present disclosure relates generally to light detection and ranging (LIDAR) systems, and more particularly to systems and methods for enhanced galvanometer (Galvo) Analog Front-End (AFE) electronics.

### BACKGROUND

Frequency-Modulated Continuous-Wave (FMCW) LIDAR systems provide precise and reliable range, direction, and reflectance measurements that can be used for obstacle avoidance or measuring characteristics such as dimensions and reflectivity of objects in a scene within the sensor's field-of-view (FoV). FMCW LIDAR systems use an optical scanner that includes scanning mirrors that rotate along an axis using actuators, such as galvanometers. To control the movement and position of the scanning mirrors, galvanometers use AFE electronics. The AFE includes an amplifier that drives the movement of the galvanometer mirror, and feedback electronics that ensure that the mirror is moving accurately and in the correct position.

### BRIEF DESCRIPTION OF THE FIGURES

Embodiments and implementations of the present disclosure will be understood more fully from the detailed description given below and from the accompanying drawings of various aspects and implementations of the disclosure, which, however, should not be taken to limit the disclosure to the specific embodiments or implementations, but are for explanation and understanding only.

FIG. 1 is a block diagram illustrating an example of a LIDAR system, according to some embodiments of the present disclosure.

FIG. 2 is a time-frequency diagram of FMCW scanning signals that can be used by a LIDAR system, according to some embodiments of the present disclosure.

FIG. 3 is a block diagram illustrating an example of positioning analog front-end electronics in proximity to galvo position drivers and sensors, according to some embodiments of the present disclosure.

FIG. 4 is a block diagram illustrating an example of moving motor driver circuitry over to a galvo sub-assembly, according to some embodiments of the present disclosure.

FIG. 5 is a block diagram illustrating an example of a galvo sub-assembly with incorporated front-end electronics, according to some embodiments of the present disclosure.

FIG. 6 is a flow diagram illustrating an example method of operating a galvo sub-assembly with incorporated front-end electronics, according to some embodiments of the disclosure.

### DETAILED DESCRIPTION

According to some embodiments, the LIDAR system described herein may be implemented in any sensing market, such as, but not limited to, transportation, manufacturing, metrology, medical, virtual reality, augmented reality, and security systems. According to some embodiments, the described LIDAR system is implemented as part of a front-end of frequency modulated continuous-wave (FMCW) device or Time of Flight (ToF) device that assists with spatial awareness for automated driver assist systems, or self-driving vehicles.

As discussed above, actuators, such as galvanometers (galvos), use AFE electronics to control the movement of a galvo mirror in laser scanning systems. The galvo AFE is an important component in laser scanning systems, as it determines the accuracy and stability of the laser beam's movement over the scan field. The galvo AFE may include optical position sensors, which are devices that use changes in light to determine the position or displacement of an object (e.g., the galvo mirror). Optical position sensors typically include a light source, such as an LED, and a photo detector or series of photo detectors, such as a photodiode, which is positioned in close proximity to a translucent or reflective code disk or opaque disk or other feature that changes light incident on the photodetectors as a function of shaft rotation. As the disk rotates, it modulates the light that reaches the photo detector, producing an electrical signal (e.g., a current signal) that is proportional to the angular position of the shaft.

A challenge found with conventional systems is that the galvo has a “passive” circuit board connected through a connector a main circuit board that includes “active” components. The passive circuit board includes the LED and photodiodes, but the remaining AFE components for driving position and sensing position are on the main circuit board. The issue with this partition is that it routes high-impedance sense nodes through the connector to achieve a given form factor for the final LiDAR design. Unfortunately, connectors carrying high-impedance nodes are sensitive to electromagnetic emissions or other interferers and cause reduced accuracy due to electrical noise during electromagnetic compatibility (EMC) qualification. In addition, the electromagnetic emissions on the connectors reduce the dynamic range and flexibility of the galvo AFE.

To eliminate routing high impedance signals through the connector, discussed herein is an approach that enhances the galvo AFE by routing low impedance analog signals or digital signals through the connector to reduce EMI susceptibility of the overall system and improve the dynamic range and flexibility of the galvo AFE. The approach partitions the front-end electronics such that sensitive analog lines are included on a small board mounted directly to the galvo and their outputs are feed through the connector to the main board. In some embodiments, the drive lines through the connector are differential (or pseudo-differential) in addition to being driven by low impedance sources. The approach enables dynamic range adjustment by controlling the LED drive voltage and the reference voltage the first stage sense amplifier in a transimpedance amplifier (TIA) discussed below. In some embodiments, the amplifier supply voltage rails are reduced by moving the front-end electronics closer to the LED and photodiode. In some embodiments, the approach controls bias voltages to improve the flexibility of the front-end and adjusts its sensitivity. In some embodiments, the approach controls the voltage using a digital to analog converter (DAC). In turn, the approach improves signal integrity, increases position knowledge accuracy, increases position knowledge resolution, and enhances dynamic range optimization.

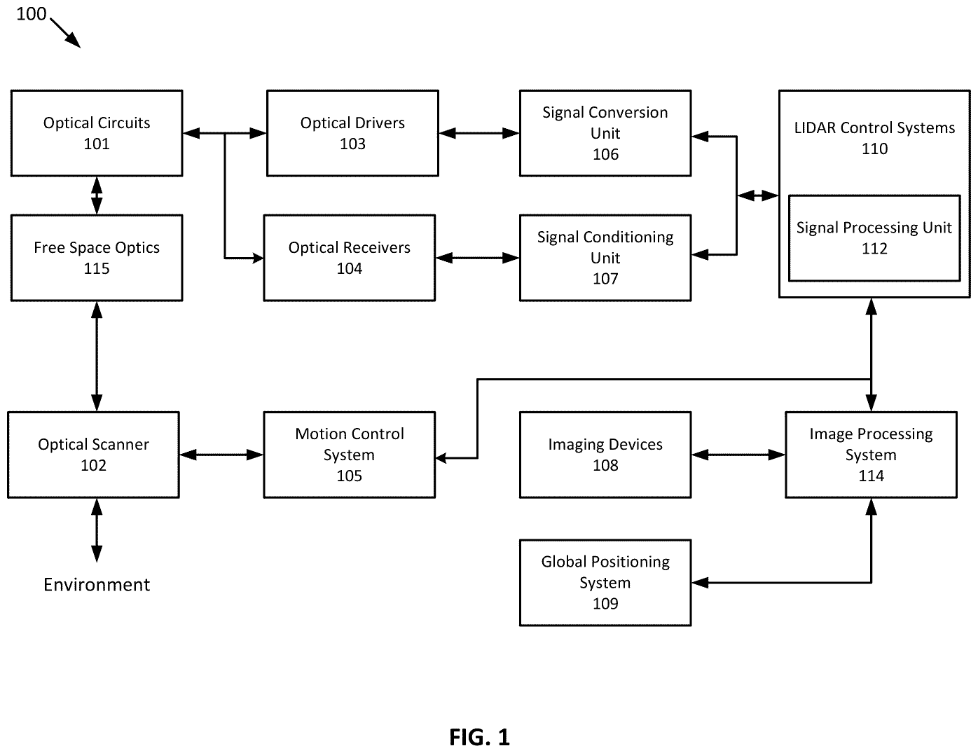

FIG. 1 is a block diagram illustrating an example of a LIDAR system, according to some embodiments. The LIDAR system 100 includes one or more of each of a number of components, but may include fewer or additional components than shown in FIG. 1. One or more of the components depicted in FIG. 1 can be implemented on a photonics chip, according to some embodiments. The optical circuits 101 may include a combination of active optical components and passive optical components. Active optical components may generate, amplify, and/or detect optical signals and the like. In some examples, the active optical component includes optical beams at different wavelengths, and includes one or more optical amplifiers, one or more optical detectors, or the like. In some embodiments, one or more LIDAR systems 100 may be mounted onto any area (e.g., front, back, side, top, bottom, and/or underneath) of a vehicle to facilitate the detection of an object in any free-space relative to the vehicle. In some embodiments, the vehicle may include a steering system and a braking system, each of which may work in combination with one or more LIDAR systems 100 according to any information (e.g., one or more rigid transformations, distance/ranging information, Doppler information, etc.) acquired and/or available to the LIDAR system 100. In some embodiments, the vehicle may include a vehicle controller that includes the one or more components and/or processors of the LIDAR system 100.

Free space optics 115 may include one or more optical waveguides to carry optical signals, and route and manipulate optical signals to appropriate input/output ports of the active optical circuit. The free space optics 115 may also include one or more optical components such as taps, wavelength division multiplexers (WDM), splitters/combiners, polarization beam splitters (PBS), collimators, couplers or the like. In some examples, the free space optics 115 may include components to transform the polarization state and direct received polarized light to optical detectors using a PBS, for example. The free space optics 115 may further include a diffractive element to deflect optical beams having different frequencies at different angles along an axis (e.g., a fast-axis).

In some examples, the LIDAR system 100 includes an optical scanner 102 that includes one or more scanning mirrors that are rotatable along an axis (e.g., a slow-axis) that is orthogonal or substantially orthogonal to the fast-axis of the diffractive element to steer optical signals to scan an environment according to a scanning pattern. For instance, the scanning mirrors may be rotatable by one or more galvanometers as discussed herein. In some embodiments, the galvanometer AFE are located within optical scanner 102. In some embodiments, some of the galvanometer AFE (e.g., main board components) are located on motion control system 105 (discussed below). Objects in the target environment may scatter an incident light into a return optical beam or a target return signal. The optical scanner 102 also collects the return optical beam or the target return signal, which may be returned to the passive optical circuit component of the optical circuits 101. For example, the return optical beam may be directed to an optical detector by a polarization beam splitter. In addition to the mirrors and galvanometers, the optical scanner 102 may include components such as a quarter-wave plate, lens, anti-reflective coated window or the like.

To control and support the optical circuits 101 and optical scanner 102, the LIDAR system 100 includes LIDAR control systems 110. The LIDAR control systems 110 may include a processing device for the LIDAR system 100. In some examples, the processing device may be one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like.

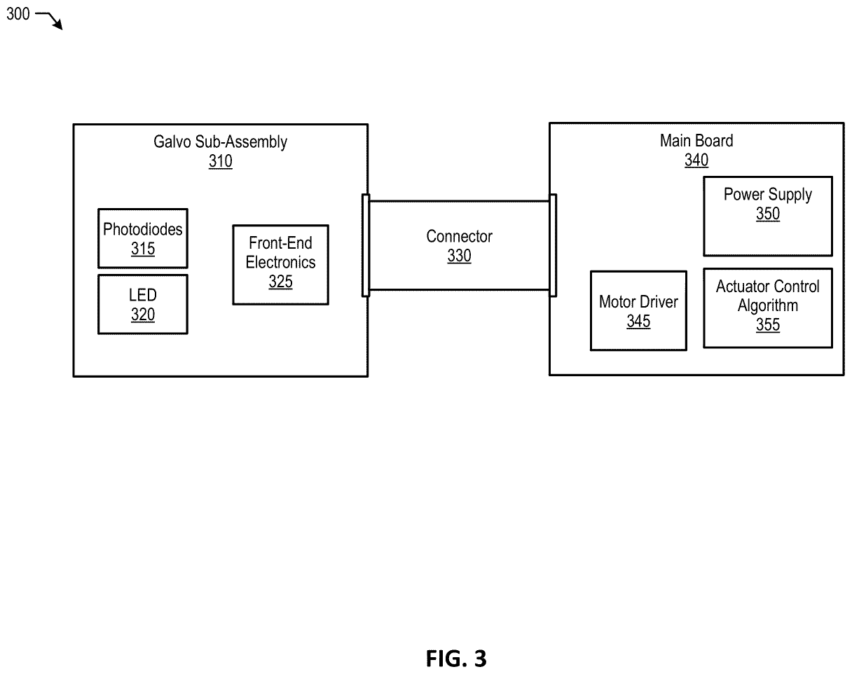

In some examples, the LIDAR control system 110 may include a processing device that may be implemented with a DSP, such as signal processing unit 112. The LIDAR control systems 110 are configured to output digital control signals to control optical drivers 103. In some examples, the digital control signals may be converted to analog signals through signal conversion unit 106. For example, the signal conversion unit 106 may include a digital-to-analog converter. The optical drivers 103 may then provide drive signals to active optical components of optical circuits 101 to drive optical sources such as lasers and amplifiers. In some examples, several optical drivers 103 and signal conversion units 106 may be provided to drive multiple optical sources. In some embodiments, optical drivers 103 includes a laser driver circuit 300 shown in FIG. 3.

The LIDAR control system 110 is also configured to output digital control signals for the optical scanner 102. A motion control system 105 may control the galvanometers of the optical scanner 102 based on control signals received from the LIDAR control systems 110. For example, a digital-to-analog converter may convert coordinate routing information from the LIDAR control systems 110 to signals interpretable by the galvanometers in the optical scanner 102. In some examples, a motion control system 105 may also return information to the LIDAR control systems 110 about the position or operation of components of the optical scanner 102. For example, an analog-to-digital converter may in turn convert information about the galvanometers' position to a signal interpretable by the LIDAR control systems 110.

The LIDAR control systems 110 are further configured to analyze incoming digital signals. In this regard, the LIDAR system 100 includes optical receivers 104 to measure one or more beams received by optical circuits 101. For example, a reference beam receiver may measure the amplitude of a reference beam from the active optical component, and an analog-to-digital converter converts signals from the reference receiver to signals interpretable by the LIDAR control systems 110. Target receivers measure the optical signal that carries information about the range and velocity of a target in the form of a beat frequency, modulated optical signal. The reflected beam may be mixed with a second signal from a local oscillator. The optical receivers 104 may include a high-speed analog-to-digital converter to convert signals from the target receiver to signals interpretable by the LIDAR control systems 110. In some examples, the signals from the optical receivers 104 may be subject to signal conditioning by signal conditioning unit 107 prior to receipt by the LIDAR control systems 110. For example, the signals from the optical receivers 104 may be provided to an operational amplifier for amplification of the received signals and the amplified signals may be provided to the LIDAR control systems 110.

In some embodiments, the LIDAR system 100 may additionally include one or more imaging devices 108 configured to capture images of the environment, a global positioning system 109 configured to provide a geographic location of the system, or other sensor inputs. The LIDAR system 100 may also include an image processing system 114. The image processing system 114 can be configured to receive the images and geographic location, and send the images and location or information related thereto to the LIDAR control systems 110 or other systems connected to the LIDAR system 100.

In operation according to some examples, the LIDAR system 100 is configured to use nondegenerate optical sources to simultaneously measure range and velocity across two dimensions. This capability allows for real-time, long range measurements of range, velocity, azimuth, and elevation of the surrounding environment.

In some embodiments, the scanning process begins with the optical drivers 103 and LIDAR control systems 110. The LIDAR control systems 110 instruct, e.g., via signal processor unit 112, the optical drivers 103 to independently modulate one or more optical beams, and these modulated signals propagate through the optical circuits 101 to the free space optics 115. The free space optics 115 directs the light at the optical scanner 102 that scans a target environment over a preprogrammed pattern defined by the motion control system 105. The optical circuits 101 may also include a polarization wave plate (PWP) to transform the polarization of the light as it leaves the optical circuits 101. In some examples, the polarization wave plate may be a quarter-wave plate or a half-wave plate. A portion of the polarized light may also be reflected back to the optical circuits 101. For example, lensing or collimating systems used in LIDAR system 100 may have natural reflective properties or a reflective coating to reflect a portion of the light back to the optical circuits 101.

Optical signals reflected back from an environment pass through the optical circuits 101 to the optical receivers 104. Because the polarization of the light has been transformed, it may be reflected by a polarization beam splitter along with the portion of polarized light that was reflected back to the optical circuits 101. In such scenarios, rather than returning to the same fiber or waveguide serving as an optical source, the reflected signals can be reflected to separate optical receivers 104. These signals interfere with one another and generate a combined signal. The combined signal can then be reflected to the optical receivers 104. Also, each beam signal that returns from the target environment may produce a time-shifted waveform. The temporal phase difference value between the two waveforms generates a beat frequency measured on the optical receivers 104 (e.g., photodetectors).

The analog signals from the optical receivers 104 are converted to digital signals by the signal conditioning unit 107. These digital signals are then sent to the LIDAR control systems 110. A signal processing unit 112 may then receive the digital signals to further process and interpret them. In some embodiments, the signal processing unit 112 also receives position data from the motion control system 105 and galvanometers as well as image data from the image processing system 114. The signal processing unit 112 can then generate 3D point cloud data (sometimes referred to as, “a LIDAR point cloud”) that includes information about range and/or velocity points in the target environment as the optical scanner 102 scans additional points. In some embodiments, a LIDAR point cloud may correspond to any other type of ranging sensor that is capable of Doppler measurements, such as Radio Detection and Ranging (RADAR). The signal processing unit 112 can also overlay 3D point cloud data with image data to determine velocity and/or distance of objects in the surrounding area. The signal processing unit 112 also processes the satellite-based navigation location data to provide data related to a specific global location.

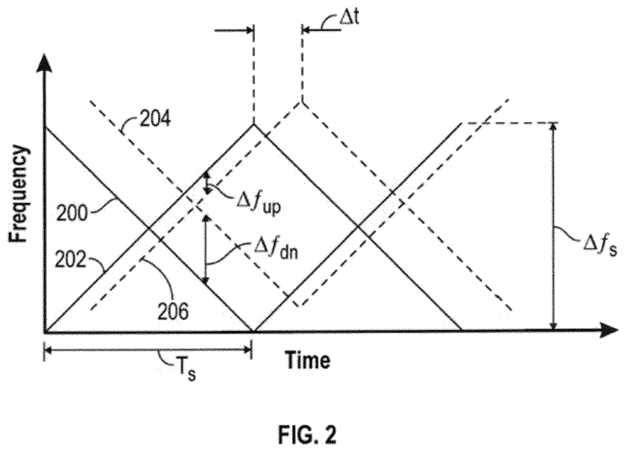

FIG. 2 is a time-frequency diagram of FMCW scanning signals that can be used by a LIDAR system according to some embodiments of the present disclosure. The FMCW scanning signals 200 and 202 may be used in any suitable LIDAR system, including the system 100, to scan a target environment. The scanning signal 200 may be a triangular waveform with an up-chirp and a down-chirp having a same bandwidth Δƒₛ and period Tₛ. The other scanning signal 202 is also a triangular waveform that includes an up-chirp and a down-chirp with bandwidth Δƒₛ and period Tₛ. However, the two signals are inverted versions of one another such that the up-chirp on scanning signal 200 occurs in unison with the down-chirp on scanning signal 202.

FIG. 2 also depicts example return signals 204 and 206. The return signals 204 and 206, are time-delayed versions of the scanning signals 200 and 202, where Δt is the round trip time to and from a target illuminated by scanning signal 201. The round trip time is given as Δt=2R/ν, where R is the target range and ν is the velocity of the optical beam, which is the speed of light c. The target range, R, can therefore be calculated as R=c(Δt/2).

In embodiments, the time delay Δt is not measured directly, but is inferred based on the frequency difference values between the outgoing scanning waveforms and the return signals. When the return signals 204 and 206 are optically mixed with the corresponding scanning signals, a signal referred to as a “beat frequency” is generated, which is caused by the combination of two waveforms of similar but slightly different frequencies. The beat frequency indicates the frequency difference value between the outgoing scanning waveform and the return signal, which is linearly related to the time delay At by the slope of the triangular waveform.

If the return signal has been reflected from an object in motion, the frequency of the return signal will also be effected by the Doppler effect, which is shown in FIG. 2 as an upward shift of the return signals 204 and 206. Using an up-chirp and a down-chirp enables the generation of two beat frequencies, Δƒᵤₚ and Δƒ_{dn}. The beat frequencies Δƒᵤₚ and Δƒ_{dn} are related to the frequency difference value cause by the range, Δƒ_{Range}, and the frequency difference value cause by the Doppler shift, Δƒ_{Doppler}, according to the following formulas:

$$Δ {f}_{u p} = Δ {f}_{R a n g e} - Δ {f}_{D o p p l e r} \qquad ( 1 )$$

$$Δ {f}_{d n} = Δ {f}_{R a n g e} + Δ {f}_{D o p p l e r} \qquad ( 2 )$$

Thus, the beat frequencies Δƒᵤₚ and Δƒ_{dn} can be used to differentiate between frequency shifts caused by the range and frequency shifts caused by motion of the measured object. Specifically, Δƒ_{Doppler} is the difference value between the Δƒᵤₚ and Δƒ_{dn} and the Δƒ_{Range} is the average of Δƒᵤₚ and Δƒ_{dn}.

The range to the target and velocity of the target can be computed using the following formulas:

$$Range = Δ {f}_{Range} \frac{{cT}_{s}}{2 Δ {f}_{s}} \qquad ( 3 )$$

$$Velocity = Δ {f}_{Doppler} \frac{{λ}_{c}}{2} \qquad ( 4 )$$

In the above formulas, λ_{c}=c/ƒ_{c} and ƒ_{c} is the center frequency of the scanning signal. The beat frequencies can be generated, for example, as an analog signal in optical receivers 104 of system 100. The beat frequency can then be digitized by an analog-to-digital converter (ADC), for example, in a signal conditioning unit such as signal conditioning unit 107 in LIDAR system 100. The digitized beat frequency signal can then be digitally processed, for example, in a signal processing unit, such as signal processing unit 112 in system 100.

In some scenarios, to ensure that the beat frequencies accurately represent the range and velocity of the object, beat frequencies can be measured at a same moment in time, as shown in FIG. 2. Otherwise, if the up-chirp beat frequency and the down-chirp beat frequencies were measured at different times, quick changes in the velocity of the object could cause inaccurate results because the Doppler effect would not be the same for both beat frequencies, meaning that equations (1) and (2) above would no longer be valid. In order to measure both beat frequencies at the same time, the up-chirp and down-chirp can be synchronized and transmitted simultaneously using two signals that are multiplexed together.

FIG. 3 is a block diagram illustrating an example actuator tracking system 300 including analog front-end electronics positioned in proximity to galvo position drivers and sensors, according to some embodiments of the present disclosure. Position sensing requires the sensing of current (e.g., receive signal) through photodiodes 315 as well as driving LED 320 to provide a signal (e.g., transmit signal) for the position sensor photodiodes to detect. The combination of drive and sense are used to interpret the position of the galvo with respect to the galvo's physical limits. System 300 incorporates the most sensitive part of the electronics (front-end electronics 325) associated with galvo position sensing within or on a galvo sub-assembly 310 to be closer to the galvo position sensing photodiodes 315 and LED 320 on galvo sub-assembly 310. In some embodiments, front-end electronics 325 is on a same circuit board as photodiodes 315 and LED 320. In some embodiments, front-end electronics 325 is on a separate circuit board coupled to photodiodes 315 and LED 320. By moving the front-end electronics closer, the system is more robust to electromagnetic interference. Furthermore, the front-end electronics may operate on a lower-supply voltage than the main processing and control circuity of the main board 340 to reduce power while also providing a mechanism for optimizing the dynamic range of the front-end electronics (e.g., LED transmitter/TIA). This level of flexibility is helpful to improve position sensing in a LiDAR system.

In some embodiments, front-end electronics 325 includes an LED driver and a transimpedance amplifier. The transimpedance amplifier (TIA) is a type of amplifier that converts a current input signal (from a photodiode) into a voltage output signal. A TIA may be used to amplify the weak signals from photodetectors, such as photodiodes and phototransistors, into a form that can be easily processed by subsequent circuits. The transimpedance gain of a TIA is typically specified in ohms, and it is the ratio of the output voltage to the input current. TIAs often incorporate feedback to stabilize their gain and bandwidth and improve their performance in the presence of noise and other disturbances.

In some embodiments, the TIA includes programmable common mode amplifier circuitry. The common mode indicates a voltage common to both input terminals of an amplifier. In some embodiments, the programmable common mode amplifier circuitry is external to the TIA and included as part of front-end electronics 325. In some embodiments, the programmable common mode sets the common mode into different electronic dispersion compensation (EDC) ranges.

In some embodiments, bias voltages are adjusted in front-end electronics 325 where one DC bias adjusts the LED current and one DC bias compensates the TIA stage for the adjusted LED current (e.g., DC shift). In some embodiments, the bias voltages are adjusted to keep a common mode output that matches an analog-to-digital (ADC) converter that the TIA is driving. In some embodiments, front-end electronics 325 dynamically adjusts the bias voltage based on, for example, a degradation in LED 320 (e.g., at system startup). In some embodiments, front-end electronics 325 dynamically adjusts (calibrates) the bias voltage based on, for example, different scan patterns with different field of views. In some embodiments, system 300 provides a level of modularity because system 300 may use photodiodes with different sensitivity, LEDs with different wavelengths, or a combination thereof without affecting other components.

By moving front-end electronics 325 closer to photodiodes 315 and LED 320, signals on connector 330 that pass to/from main board 340 are low impedance and are therefore less susceptible to EMI. Main board 340 includes motor driver 345 to drive the motor of galvo sub-assembly 310, and power supply 350 provides power to galvanometer. In some embodiments, front-end electronics 325 is powered by a different supply voltage than the motor drive of galvo sub-assembly 310. As such, transients on the motor drive voltage do not couple over to the supply voltage of front-end electronics 325. Actuator control algorithm 355 provides and receives position information to/from front-end electronics 325.

In some embodiments, front-end electronics 325 includes an encoder that performs feedback control of the LED intensity to compensate for aging effects, where measurement of the sum of the photodiode signals allows measurement of the LED intensity. In some embodiments, front-end electronics 325 performs on/off modulation of the LED to enable correlated double sampling. The on/off modulation provides various benefits such as interleaved measurement of signal and noise, and modulation of the signal to high frequency to reject 1/f and other low-frequency noise sources.

In some embodiments, front-end electronics 325 monitors the noise levels on the photodiodes to detect changes introduced by external interference or part failures. In some embodiments, front-end electronics 325 includes a fault signal safety mechanism that is generated when, for example, the LED intensity (or compensating signal) has changed by more than a configurable threshold; the measured noise amplitude on any of the photodiodes exceeds a configurable threshold; the measured signal level on any of the photodiodes drops below a configurable threshold, or a combination thereof.

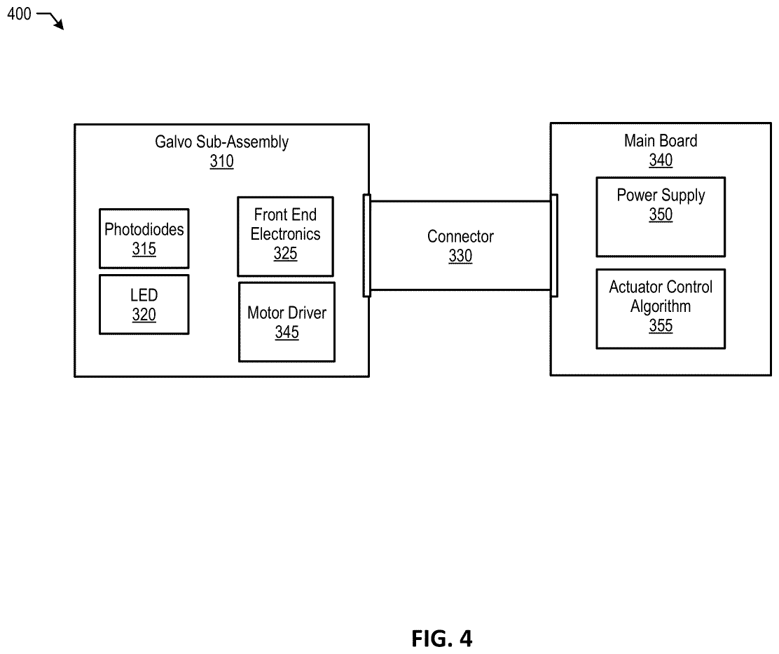

FIG. 4 is a block diagram illustrating an example actuator tracking system 400 in which motor driver circuitry is incorporated at galvo sub-assembly 310, according to some embodiments of the present disclosure. System 400 depicts motor driver 345 on galvo sub-assembly 310. In this embodiment, signal integrity is further enhanced by eliminating the need to send high current pulses through connector 330. Instead, main board 340 sends an average current pulse (e.g., pulse-width modulated (PWM) signal) through connector 330 to control motor driver 345 that, in turn, reduces transients on connector 330.

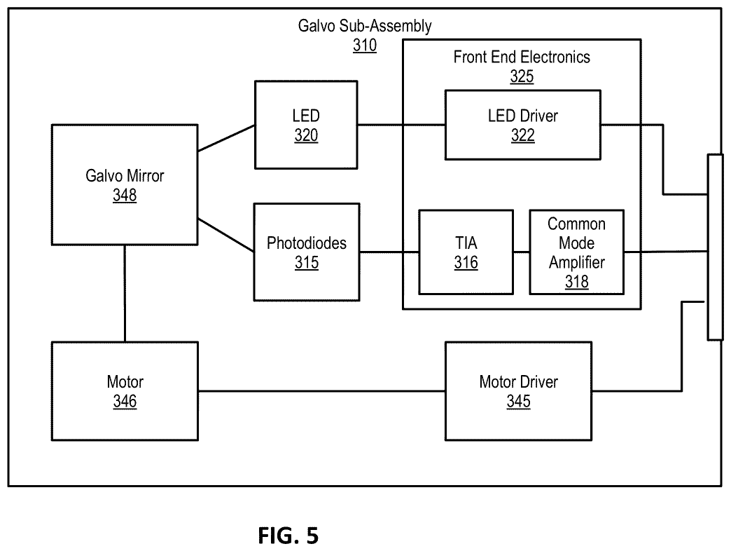

FIG. 5 is a block diagram illustrating an example of a galvo sub-assembly 310 with incorporated front-end electronics, according to some embodiments of the present disclosure. As depicted, front-end electronics 325 may include LED driver 222 to receive a low-impedance signal from connectors 430 to control the LED 320. The front-end electronics 325 may also include a TIA 316 to amplify an output signal (e.g., an electrical current) and to generate a low impedance output signal. By incorporating the TIA 316 near the photodiodes 315, the traces are shortened to minimize the amount of noise picked up in the photodiode 315 output signal and amplified by the TIA 316.

In some embodiments, the front-end electronics 325 further includes programmable common mode amplifier circuitry 318 either as part of the TIA 316 or as a separate component. The common-mode amplifier 318 may be a type of differential amplifier with two inputs that amplifies the average of the voltage between the two input signals, rejecting any voltage differences between the inputs. Accordingly, the small signal of the photodiode 315 may be superimposed on a larger, varying common-mode voltage. The common mode amplifier 318 may allow the differential signal (the signal of interest) to be amplified (e.g., by TIA 316) while the common-mode signal (the noise) is rejected, resulting in a cleaner, stronger signal. In some examples, the common mode indicates a voltage common to both input terminals of an amplifier. In some embodiments, the programmable common mode sets the common mode into different electronic dispersion compensation (EDC) ranges.

In some embodiments, the LED 320 strength is adjustable, based on a signal to the LED driver 322, which in turn also adjust the signal of photodiodes 315. The adjusted output signal of the photodiodes 315 further adjusts the gain of the circuit. However, this will result in a stronger DC level which should be accounted for. Accordingly, one DC biases may be used to set the LED 320 current, to compensate the TIA stage so that its output is maintained at a common mode that matches an analog to digital convert to which it is being driven. Accordingly, the adjustable LED signal and the adjustable biases to account for the changes in DC signal provide for programmable ranges that compensates on the transmit side and the receive side.

In some embodiments, the galvo sub-assembly 310 include a galvo mirror 348 to direct an output beam to a field of view of a LIDAR system. The galvo mirror 348 may be moved or actuated by a motor 346. The motor 346 may be controlled by a motor driver 345 that received a control signal and drives a voltage to the motor 346 to position the galvo mirror 348 according to the control signal. In some examples, the motor driver 345 may also receive feedback from the motor 346 regarding the position of the motor 346 and thus the galvo mirror 348. The motor driver 345 may return the feedback signal to, for example, an actuator control algorithm which may use the feedback signal along with the amplified photodiode 315 signal to determine a position of the galvo mirror 348 and to adjust or calculate next movements of the galvo mirror 348 and moto 346 based on a scan pattern of the LIDAR system.

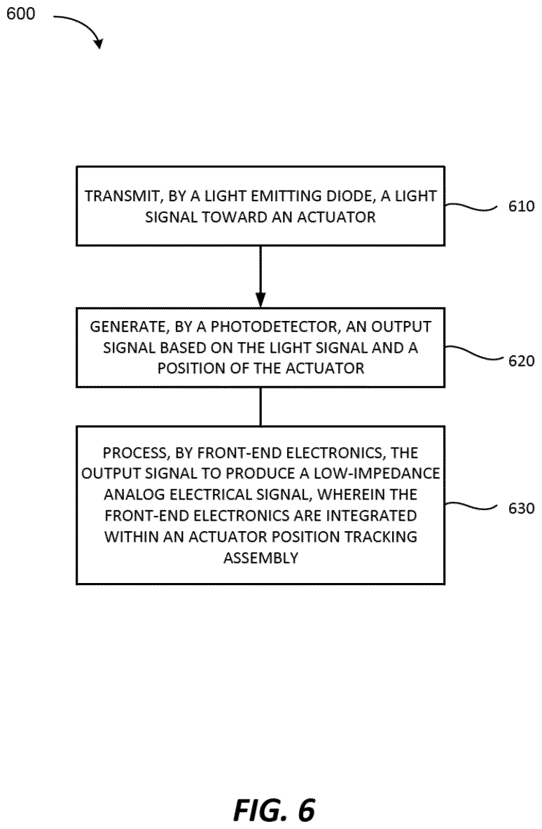

FIG. 6 is a flow diagram illustrating an example method 600 of operating a galvo sub-assembly with incorporated front-end electronics, according to some embodiments of the disclosure. Method 600 may begin at block 610, where an LED transmits a light signal toward an actuator. The LED may be driven by a local LED driver incorporated on the galvo sub-assembly of a LIDAR system. The LED driver may include a DC bias to control an intensity of the LED which may, in turn, be controlled by circuitry at a main electronics board of the LIDAR system.

At block 620, a photodetector generates an output signal based on the light signal and position of the actuator. For example, the LED signal may be modulated, reduced, or otherwise encoded based on a position of the actuator. The output of the photodetector may be a current that is dependent on the intensity of the light received by the photodetector.

At block 630, front-end electronics process the output signal of the photodetector to produce a low-impedance analog electrical signal, wherein the front-end electronics are integrated within an actuator position tracking assembly (e.g., at the galvo sub-assembly). In some embodiments, the front-end electronics incorporated on the galvo sub-assembly includes an analog signal amplifier coupled to the photodiode to amplify an output signal received from the photodiode and an LED driver coupled to the light emitting diode. In some embodiments, the analog signal amplifier includes a trans-impedance amplifier and a common mode amplifier circuit. In some embodiments, the actuator position tracking assembly further includes a motor driver coupled to a motor of the actuator.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. While this specification contains many specific implementation details, these should not be construed as limitations on the scope of any embodiment of the present disclosure or of what may be claimed, but rather as descriptions of features specific to particular embodiments of the present disclosure. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination. Moreover, the separation of various system components in the embodiments described above should not be understood as requiring such separation in all embodiments, and it should be understood that the described program components and systems can generally be integrated together in a single software product or packaged into multiple software products. Particular embodiments may vary from these exemplary details and still be contemplated to be within the scope of the present disclosure.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

Although the operations of the methods herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be in an intermittent or alternating manner.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A light detection and ranging (LIDAR) system comprising:
an actuator assembly;
actuator position tracking circuitry, comprising:
a light emitting diode (LED) to emit a first signal toward an actuator;
a photodiode to receive a second signal based on a position of the actuator and generate an output signal; and
at least one front-end electronics to produce a low-impedance analog electrical signal based on the output signal.

2. The system of claim 1, wherein the at least one front-end electronics comprises:
an analog signal amplifier coupled to the photodiode to amplify the output signal received from the photodiode; and
an LED driver coupled to the light emitting diode.

3. The system of claim 2, wherein the analog signal amplifier comprises a transimpedance amplifier.

4. The system of claim 3, wherein the analog signal amplifier further comprises a common mode amplifier circuit.

5. The system of claim 1, wherein the actuator assembly further comprises:
a motor driver coupled to a motor of the actuator.

6. The system of claim 1, wherein the front-end electronics are incorporated on an integrated circuit chip directly coupled to the actuator assembly.

7. The system of claim 1, wherein the motor driver provides a feedback associated with a position of the actuator, and wherein a position of the actuator is determined based on a signal from the photodiode and the feedback of the motor driver.

8. The system of claim 1, wherein the actuator comprises a galvanometer of a galvo mirror.

9. An actuator position tracking circuitry, comprising:
a light emitting diode (LED) to emit a first signal toward an actuator;
a photodiode to receive a second signal based on a position of the actuator and generate an output signal; and
at least one front-end electronics to produce a low-impedance analog electrical signal based on the output signal.

10. The circuity of claim 9, wherein the at least one front-end electronics comprises:
an analog signal amplifier coupled to the photodiode to amplify the output signal received from the photodiode; and
an LED driver coupled to the light emitting diode.

11. The circuity of claim 10, wherein the analog signal amplifier comprises a transimpedance amplifier.

12. The circuity of claim 11, wherein the analog signal amplifier further comprises a common mode amplifier circuit.

13. The circuity of claim 9, wherein the actuator assembly further comprises:
a motor driver coupled to a motor of the actuator.

14. The circuity of claim 9, wherein the front-end electronics are incorporated on an integrated circuit chip directly coupled to the actuator assembly.

15. The circuity of claim 9, wherein the motor driver provides a feedback associated with a position of the actuator, and wherein a position of the actuator is determined based on a signal from the photodiode and the feedback of the motor driver.

16. The circuity of claim 9, wherein the actuator comprises a galvanometer of a galvo mirror.

17. A method of operating an actuator position tracking assembly, comprising:
transmitting, by a light emitting diode, a light signal toward an actuator;
generating, by a photodetector, an output signal based on the light signal and a position of the actuator; and
processing, by at least one front-end electronics, the output signal to produce a low-impedance analog electrical signal.

18. The method of claim 17, wherein the at least one front-end electronics comprises:
an analog signal amplifier coupled to the photodiode to amplify an output signal received from the photodiode; and
an LED driver coupled to the light emitting diode.

19. The method of claim 18, wherein the analog signal amplifier comprises a transimpedance amplifier and a common mode amplifier circuit.

20. The method of claim 17, wherein the actuator position tracking assembly comprises a motor driver coupled to a motor of the actuator.
